(19) United States
(12) Patent Application Publication
(10) Pub. No.: US 2003/0029788 A1
(43) Pub. Date: Feb. 13, 2003

(54) Pleated filter element

(76) Inventors: Geert Denys, Horebeke (BE); Geert Devooght, Koekelare (BE)

Correspondence Address: FOLEY AND LARDNER, SUITE 500, 3000 K STREET NW, WASHINGTON, DC, 20007, US

(21) Appl. No.: 10/203,923

(22) PCT Filed: Feb. 14, 2001
(86) PCT No.: PCT/EP01/01592

(30) Foreign Application Priority Data
Feb. 23, 2000 (EP) 00200624.5

(51) Int. Cl. B01D 27/06

(52) U.S. Cl. 210/493.1; 210/510.1

(57) ABSTRACT

A filter element for filtering high temperature gas or liquid is provided. The filter element comprise a sintered metal fiber fleece being pleated and bent to provide pleating lines extending from a central axis outwards.

### FIELD OF THE INVENTION

The present invention relates to a high temperature filter element, comprising a sintered metal fiber fleece.

### BACKGROUND OF THE INVENTION

High temperature resistant filter elements comprising sintered metal fiber fleeces are known in the art, e.g. from U.S. Pat. No. 5,215,724.

Pleated sintered metal fiber fleeces are also known. Pleats are applied in such a way that in the final filter element, pleating lines run parallel one to another. The pleated filter surfaces are flat or cylindrical, having pleats running parallel to a central axis.

Disadvantages of these types are that the filter surface per volume is limited. Further, special measures are to be taken into account to provide an acceptable pressure drop and equal flow distribution over the whole filter surface.

### SUMMARY OF THE INVENTION

It is an object of the invention to provide a high temperature filter element, which comprises a pleated sintered metal fiber fleece, having an improved filter surface/volume ratio, a lowered pressure drop and an equal flow distribution over its whole filtration surface. Further the high temperature filter element as subject of the invention can be produced more economically and with less risk on damaging the sintered metal fiber fleece during manipulation and production. It is also an objective of the invention to provide a method to produce a high temperature filter element comprising a pleated sintered metal fiber fleece.

A filter element as subject of the invention comprises an outer wall and a sintered metal fiber fleece, concertina-like pleated and bent in such a form that the pleating lines extend from a central axis radial towards the outer wall of the filter element. The outer wall encloses this central axis. Eventually an inner wall is provided. Since the filter is intended to be used in high temperature environments, these walls are usually made out of metal, e.g. steel. The filter element is to be part of a filter system, which has an inlet, via which the liquid or gas to be filtered is provided to the filter element, and an outlet, via which the filtered liquid or gas is evacuated from the filter element.

Each pleat of the pleated sintered metal fiber fleece comprises 2 walls of sintered metal fiber material which are limited by 3 pleating lines, an outer pleat opening and eventually an inner pleat opening, depending on the nature of the bending used.

Outer and eventually inner openings are to be closed, in order to allow high temperature gas or liquid to flow from the inlet of the filter, via the pleats, through the sintered metal fiber walls being the filter medium, towards the outlet of the filter element. This sealing has to be perfectly closed, to prevent by-pass of non-filtered liquid or gas through the edges of the filter media.

The outer pleat openings are closed by connecting the outer edge of the sintered metal fiber walls to the outer wall of the filter element. This connection is to be established quick, and should resist the working temperature of the filter element. This connection and sealing can be performed by gluing with appropriate glues, or the sintered metal fiber fleece can be welded to the outer wall, e.g. by laser welding.

An alternative however, which is to be preferred, uses an outer wall comprising an upper and a lower part. The outer edge of the pleated sintered metal fiber fleece is to be positioned and squeezed between those two parts. Therefor, the edge of the upper part, coming into contact with the pleated sintered metal fiber fleece has a waved shape, identical to the waved shape of the outer edge of the sintered metal fiber fleece due to the pleating and bending. The edge of the lower part, coming into contact with the pleated sintered metal fiber fleece has also a waved shape, identical to the waved shape of the outer edge of the sintered metal fiber fleece due to the pleating and bending. The pleated sintered metal fiber fleece is positioned and squeezed between upper and lower part of the outer wall, in such a way that the outer pleat openings are closed by the waves on the edges of the two parts. The upper part, pleated sintered metal fiber fleece and the lower part are welded to each other at the outer side by laser welding, plasma welding, TIG-welding or resistance welding in order to keep the sintered metal fiber fleece into its shape and to keep the pleat openings closed. Alternatively, but less preferred, the three parts may be connected to each other by gluing. This gluing or welding is done preferably at the outer side of the outer wall. Due to the compressibility of the sintered metal fiber fleece, the leakage of high temperature gas or liquid towards the exterior of the filter element is minimized, if not prevented, so a seal is made and by-pass of non-filtered liquid or gas is prevented.

Eventually, the filter element is mounted in a second external wall, which fit closely to the outer wall of the filter element. The eventual leakage via the sintered metal fiber fleece through the outer wall to the exterior is prevented.

The inner pleat openings may be closed by the nature of the bending operation, but usually, the pleats extend in an open core area. In the latter situation, the inner pleat openings have to be closed by e.g. welding or gluing the sintered metal fiber fleece on an inner wall. Identically as for the outer wall, an inner wall comprising two parts, a lower and an upper part may be used. The inner edge of the pleated sintered metal fiber fleece is squeezed between waves on the upper and lower parts and connected by gluing, or welding. An extra second internal wall may be applied to prevent eventual by-pass of non-filtered liquid or gas via the sintered metal fiber fleece through the inner wall to the interior.

An alternative to close the open core area uses a sintered metal fiber tube, with an outer diameter that is minimally the diameter of the open core area. This sintered metal fiber tube is inserted in the open core area. This sintered metal fiber tube is then pressed against the edge of the inner pleat openings with one or more cylindrical or conical elements. This can be done by inserting a cylinder of tube in this sintered metal fiber tube, provided that the outer diameter of this cylinder or tube is slightly larger than the inner diameter of the sintered metal fiber tube. If necessary, end parts may be mounted, e.g. screwed, on this cylinder or tube to fix the cylinder or tube.

More preferred however, two slightly conical parts are brought into the sintered metal fiber tube, one at each side of the tube and with the small diameter pointing inwards the sintered metal fiber tube. The conical shape is chosen in such a way that the smallest diameter of the cone is smaller than the inner diameter of the sintered metal fiber tube, whereas the largest diameter of the conical part is slightly larger than the inner diameter of the sintered metal fiber tube. The height of the conical parts is half of the length of the sintered metal fiber tube. Both conical parts are forced into the sintered metal fiber tube till they meet halfway inside the sintered metal fiber tube, where they are connected to each other, e.g. by pressing, welding or gluing. The conical parts force the sintered metal fiber tube outwards against and partially in the inner pleat openings. The inner pleat openings of the sintered metal fiber fleece are closed and sealed by the sintered metal fiber tube.

A person skilled in the art understands that it is not obvious to pleat and bend a sintered metal fiber fleece in a filter element as subject of the invention.

Sintered metal fiber fleeces are much more difficult to bend after pleating, compared to other fleece-like filter media, e.g. filter paper. The outer edge of the pleated sintered metal fiber fleece tends to move in an uncontrolled way outwards.

To avoid rejected filter elements, it is to be preferred to close the outer pleat openings and so to connect the pleated sintered metal fiber fleece to the outer wall immediately after pleating and bending, using as less mechanical actions as possible. Doing so, the shape of the pleats are secured during further processing of the filter element and during the use of the filter element.

Because of its simplicity, the use of an outer wall comprising two waved parts is preferred.

Filter elements with a circular outer an eventually inner wall are to be preferred, however other geometry's are possible.

A filter element as subject of the invention provides a higher filtering surface per volume compared to filter elements, of which the pleats run parallel to each other.

A filter surface/volume ratio of more than 0.25 mm²/mm³ may be obtained. Preferably, a filter surface/volume ratio of more than 0.3 mm²/mm³, or even more than 0.5 mm²¹ mm³ may be obtained, still having a filter with reasonable pressure drop and filtering properties.

An additional advantage is that, when the inlet and outlet of the filter element is located above and beyond the central axis, of which the pleats extend, a better distribution of the liquid or gas over the whole filter surface, and a lower pressure drop over the filter element is provided.

Another advantage of the use of a sintered metal fiber fleece and a metal inner an outer wall, is that these three elements can be welded to each other. When glues are used to connect these elements, the connection and seal is more easily broken due to different thermal coefficient of expansion or by thermal or mechanical shocks.

According to the specific use of the filter element, different sintered metal fiber fleece may be used to provide appropriate filtration properties. Stainless steel sintered fleeces are preferred. Stainless steel fibers may e.g. be bundle drawn or shaved, with fiber equivalent diameters of ranging from 1 μm to 100 μm. If required, different layers of sintered metal fiber fleece may be used, one on top of the other.

The alloy of the metal fibers is to be chosen in order to resist the working circumstances of the filter element. Stainless steel fibers out of AISI 300-type alloys, e.g. AISI 316L are preferred in case temperatures up to 360° C. are to be resisted. Fibers based on INCONEL®-type alloys such as INCONEL®601 or HASTELLOY®-type alloys such as HASTELLOY® HR may be used up to 500° C., respectively 560° C. Fibers based on Fe—Cr—Al alloys may be chosen to resist temperatures up to 1000° C. or even more.

Equivalent diameter is to be understood as the diameter of a radial cut of an imaginary round fiber, having an identical surface as the radial cut of the fiber under consideration.

Filter elements as subject of the invention can be used to filter exhaust gases of combustion engines, e.g. to trap the soot particles. They may be used as a carrying element for catalysts, e.g. in the exhaust system of combustion engines.

### BRIEF DESCRIPTION OF THE DRAWINGS

The invention will now be described into more detail with reference to the accompanying drawings wherein

FIG. 1 shows a pleated strip of sintered metal fiber fleece.

FIG. 2 shows a concertina-like pleated and bent sintered metal fiber fleece.

FIG. 3 shows a sintered metal fiber fleece, being squeezed by two parts of an outer wall.

FIG. 4 shows a filter element as subject of the invention, being pressed in a close fitting secondary outer wall

FIG. 5 is a view of an inner wall, comprising two parts which squeezes a sintered metal fiber fleece

FIG. 6 shows the closing of the inner pleats by means of a sintered metal fiber tube and two conical parts.

FIG. 7 shows another pleated strip of sintered metal fiber fleece

FIG. 8 shows an alternative method of bending a sintered metal fiber fleece.

### DESCRIPTION OF THE PREFERRED EMBODIMENTS OF THE INVENTION

An embodiment of a filter element as subject of the invention is provided by applying following steps.

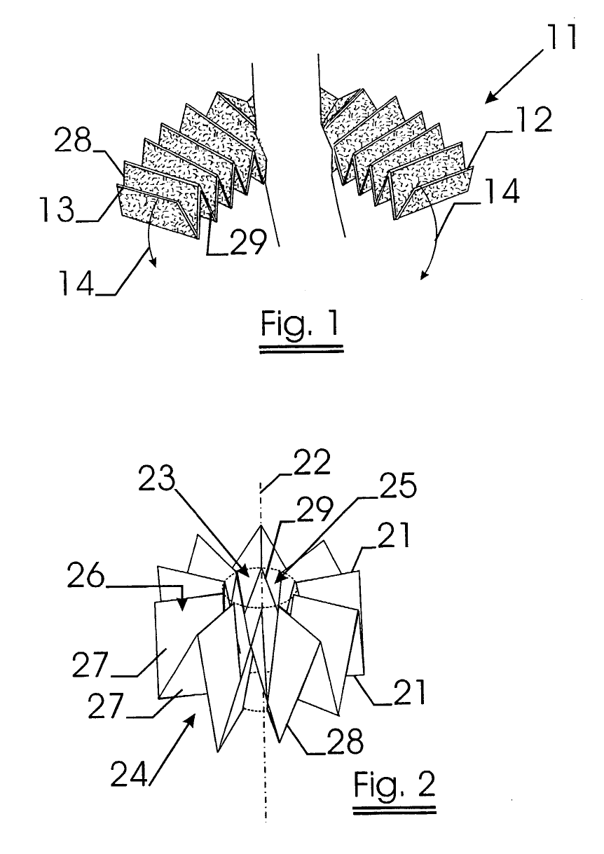

As shown in FIG. 1, a rectangular sintered metal fiber fleece 11 is concertina-like pleated. The two straight edges 12 and 13 are bent towards each other as indicated by arrows 14. Straight edges 12 and 13 are connected to each other by gluing, clamping or welding, e.g. resistance welding. As shown in FIG. 2, a closed circular shaped, concertina-like pleated sintered metal fiber fleece is obtained, comprising pleating lines 21 extending outwards from a central axis 22, outer pleat openings 24, inner pleat openings 23 and a core area 25. Two sintered metal fiber walls 27 limit each pleat 26. The sintered metal fiber fleece has an inner edge 29 and an outer edge 28, each having a waved shape due to the pleating and bending operation.

A sintered metal fiber fleece pleated as shown in FIG. 2, tends to deform. The outer edge 28 tends to remote itself away from the central axis 22 in radial direction. This may even induce defects in the sintered metal fiber walls, causing malfunctioning of the filter element. These defects cannot be removed completely once occurred.

To avoid deformation, it was found that it is sufficient to connect the outer edge 28 of the sintered metal fiber fleece to the outer wall of the filter element, so securing and preventing the pleats to change shape during further processing.

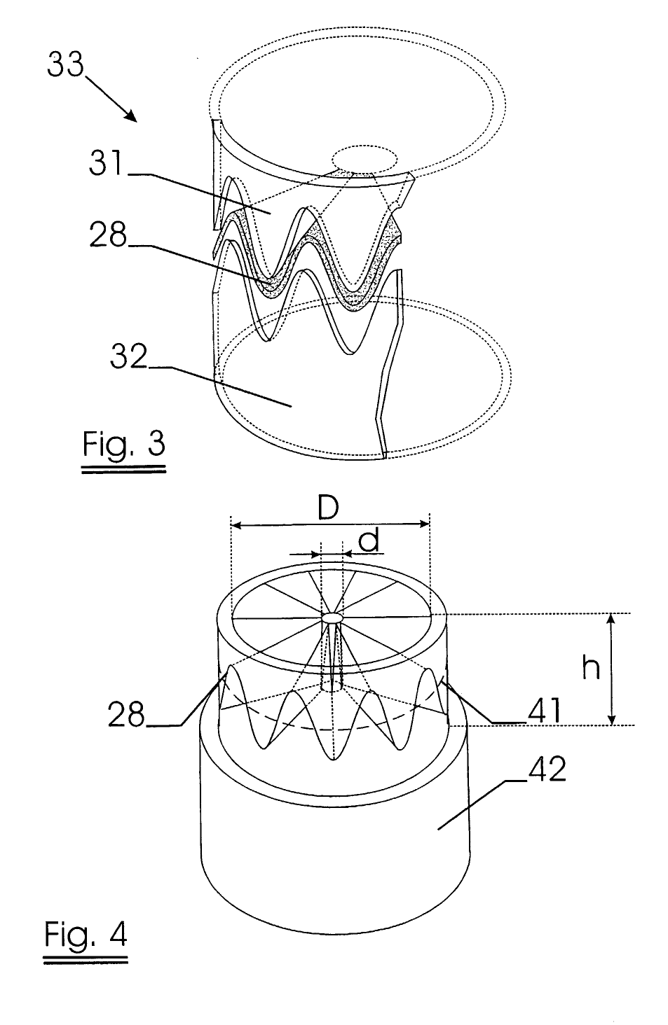

To secure the pleat shapes, a preferred method is shown in FIG. 3. The outer edge 28 of the pleated sintered metal fiber fleece is squeezed between a upper part 31 and a lower part 32 of the outer wall 33. Upper and lower parts are formed at one side to the wave shape of the pleated sintered metal fiber fleece, occurring at the outer edge 28. Upper part 31, outer edge 28 and lower part 32 are mounted and pressed to each other. They are permanently connected to each other by gluing them to each other, or by welding them to each other. This gluing or welding is preferably done at the outer side of the outer wall 33.

As shown in FIG. 4, laser welding, plasma welding, TIG-welding or resistance welding can be applied round the periphery of the outer wall, following the waved shape of the outer edge 28 of the sintered metal fiber fleece, or by following a circle 41 round the outer wall, coming into contact with the upper and lower part several times.

To prevent eventual leakage of gas or liquid through the outer wall via the sintered metal fiber fleece, a second external wall 42 may be used. The filter element is pressed in a close fitting second external wall 42. The risk on leakage is already reduced since the outer edge 28 of the sintered metal fiber fleece is already compressed by the upper and lower part of the outer wall.

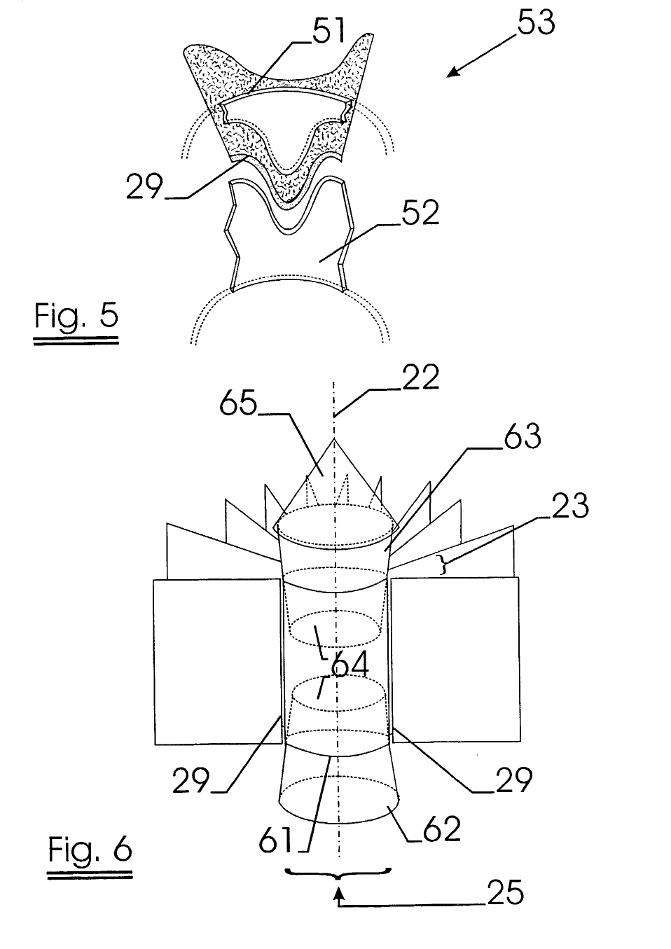

As shown in FIG. 5, inner pleat openings, if any, can be closed in a similar way. Inner edge 29 is squeezed between upper part 51 and lower part 52 of the inner wall 53. Upper and lower parts are formed at one side to the wave shape of the pleated sintered metal fiber fleece, occurring at the inner edge 29. Upper part 51, inner edge 29 and lower part 52 are mounted and pressed to each other. They are permanently connected to each other by gluing them to each other, or by welding them to each other. This gluing or welding is preferably done at the inner side of the inner wall 53. Applying a second, close fitting internal wall may further prevent leakage of gas or liquids through the inner wall.

An alternative method to close inner pleat openings is shown in FIG. 6. A sintered metal fiber tube 61 is inserted in the open core area 25. The external diameter of the sintered metal fiber tube is minimally equal to the diameter of this open core area. Two slightly conical parts 62 and 63 are brought in the sintered metal fiber tube, the smallest diameter pointing inwards of the sintered metal fiber tube. This smallest diameter is slightly smaller than the inner diameter of the sintered metal fiber tube. The largest diameter of the conical parts is slightly larger than the inner diameter of the sintered metal fiber tube. Their smallest end surfaces 64 meet approximately in the middle of the sintered metal fiber tube, where both conical parts are connected to each other, e.g. by welding, gluing or pressing. Eventually, the top 65 of the element 63, pointing towards the inlet of the filter element, may be conical to further improve the flow distribution. The openings are closed since the conical parts force the sintered metal fiber tube partially in the openings and force the edge firmly against the inner side of the sintered metal fiber tube.

As a preferred embodiment, a filter element as in FIG. 6 was provided, having different dimensions. As shown in TABLE I, high filter surface/volume (R1) and medium volume/filter volume (R2) was obtained. As filter medium, a sintered metal fiber fleece made out of stainless steel fibers having an equivalent diameter of 35 μm was used. The sintered metal fiber fleece has a thickness of 1.25 mm.

TABLE I

| D | d | H | Volume | Surface | Thickness | Ratio | |
|---|---|---|---|---|---|---|---|
| (mm) | (mm) | (mm) | (mm³) | fleece (mm²) | (mm) | R1 | R2 |
| 110 | 55 | 50 | 356363 | 190000 | 1.25 | 0.533 | 0.666 |
| 100 | 50 | 200 | 1178063 | 625000 | 1.25 | 0.531 | 0.663 |
| 60 | 30 | 35 | 74218 | 40000 | 1.25 | 0.539 | 0.674 |
| 110 | 27 | 50 | 446525 | 141000 | 1.25 | 0.316 | 0.395 |
| 100 | 25 | 200 | 1472578 | 471000 | 1.25 | 0.320 | 0.400 |
| 60 | 15 | 35 | 92772 | 30000 | 1.25 | 0.323 | 0.404 |

The filter surface/volume ratio (R1) is the total surface of the filter medium, divided by the total volume of the filter element, in which the filter surface (or filter medium) is comprised.

The medium volume/filter volume ratio (R2) is the total volume of the filter medium, divided by the total volume of the filter element, in which the filter surface (or filter medium) is comprised.

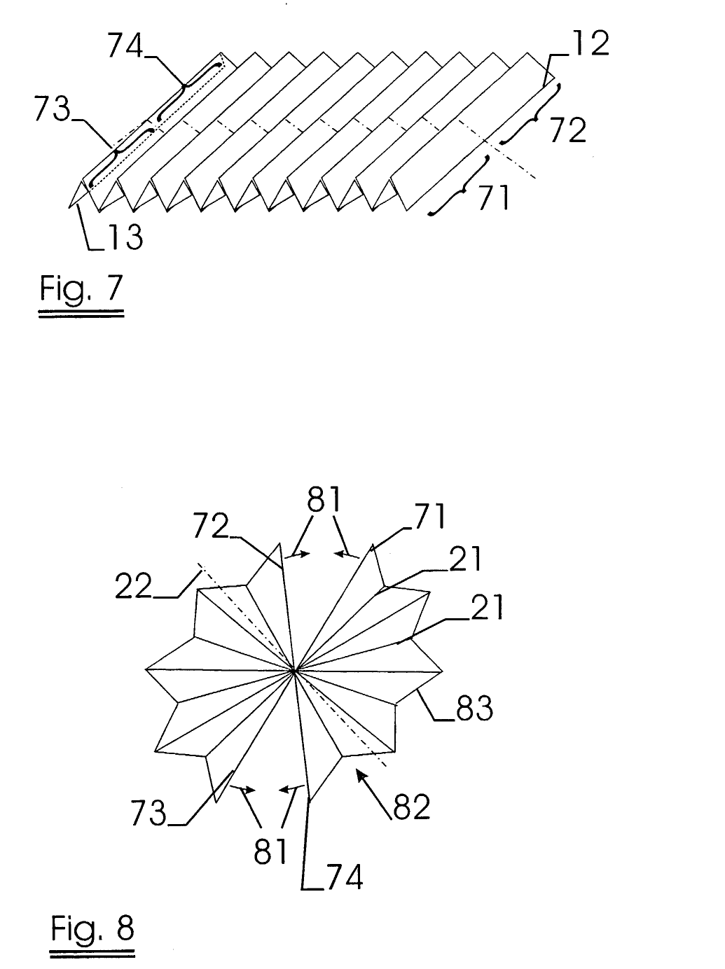

An alternative embodiment of a pleated sintered metal fiber fleece, to provide a filter element as subject of the invention, is shown in FIG. 7 and FIG. 8. The straight edges 12 and 13 are divided in 2 equal parts, being 71 and 72 for edge 12 and 73 and 74 for edge 13. Edge part 71 and 72 are bent towards each other and connected, e.g. by welding or gluing. Edge part 73 and 74 are also bent to each other and connected by welding, clamping or gluing.

This embodiment provides a pleated sintered metal fiber fleece having no inner pleat openings to be closed. Pleats have pleating lines 21 extending outwards from a central axis 22. Also this embodiment tends to deform. The outer pleat openings 82 can be closed and so securing the pleat shape. This can be done by welding or gluing the outer edge 83 to the outer wall, or by squeezing the outer edge 83 between two part of an outer wall as described above.

A person skilled in the art understands that other embodiments, having different outer geometry, are obtainable in a similar way. It is clear that for other embodiments, the sintered metal fiber fleece does not have to be rectangular, nor that all pleats are parallel to each other before the pleated sintered metal fiber fleece is bent. The term “straight edge” is to be understood then as the part of the edge of the sintered metal fiber fleece, which is to be bent and connected to each other.

Filter elements as subject of the invention are preferably used in filter systems having the inlet and outlet point lined up with the central axis of the pleated sintered metal fiber fleece. Liquids and gasses to be filtered, are to flow mainly in the direction of this central axis. Since there is no change of flow direction, a smaller pressure drop will be found over the filter element. Further, liquid or gas flow meeting the filter element, will be directed in all pleats of the sintered metal fiber fleece, so providing the filter element of having a preferred filtering zone. The filter element will be loaded equally over its full surface, so improving the filtration capacity.

During use of the filter element, the pleats will be kept in their shape as originally introduced. The connection of the sintered metal fiber fleece with the outer wall as subject of the invention will prevent the pleats of collapsing due to the application of the filter.

1. A filter element for filtering high temperature gas or liquid, comprising an outer wall and a sintered metal fiber fleece being pleated according to pleating lines, characterized in that said pleated sintered metal fiber fleece is bent providing an outer edge and a central axis, said pleating lines extending from said central axis radial towards said outer wall of said filter element.

2. A filter element as in claim 1, wherein the outer edge of said pleated sintered metal fiber fleece is welded to the outer wall of said filter element.

3. A filter element as in claim 1, wherein said outer wall comprising a upper part and a lower part, one side of said upper and lower part being formed to the waved shape of said outer edge of said sintered metal fiber fleece, said outer edge of said pleated sintered metal fiber fleece being squeezed between said upper and lower part of said outer wall.

4. A filter element as in claim 3, wherein said upper part, said outer edge of said sintered metal fiber fleece and said lower part being welded together at outer side of said outer wall.

5. A filter element according to claim 1 to 4, wherein pleats extending in an open core area at said inner edge of said pleated sintered metal fiber fleece, characterized in that a sintered metal fiber tube is pressed against inner edge of said sintered metal fiber fleece.

6. A filter element according to claim 5, wherein pleats extending in an open core area at said inner edge of said pleated sintered metal fiber fleece, characterized in that a sintered metal fiber tube is pressed against inner edge of said sintered metal fiber fleece by two conical parts, one of said conical parts being brought into said sintered metal fiber tube at each side with smallest diameter pointing inwards of said sintered metal fiber tube, and both said conical parts being connected to each other.

7. A filter element as in claim 1 to 6, wherein a second external wall is fit closely to said outer wall.

8. Use of a filter element as in claim 1 to 7 as a soot particle filter.

9. Use of a filter element as in claim 1 to 7 as catalyst carrier.

10. Method of providing a filter element comprising the steps:
pleating a sintered metal fiber fleece;
bending said pleated sintered metal fiber fleece by bringing straight edges to each other in order to obtain pleating lines extending outwards from a central axis;
closing said straight edges;
connecting outer edge of said sintered metal fiber fleece to the outer wall of said filter element;
closing inner pleat openings, if any, by connecting inner edge of sintered metal fiber fleece to the inner wall of said filter element.

11. Method of providing a filter element comprising the steps:
pleating a sintered metal fiber fleece;
bending said pleated sintered metal fiber fleece by bringing straight edges to each other in order to obtain pleating lines extending outwards from a central axis;
closing said straight edges;
squeezing outer edge of said sintered metal fiber fleece between a upper and a lower part of the outer wall of said filter element, said upper and lower part of said outer wall being formed at one side according to the wave shape of said outer edge of said sintered metal fiber fleece;
closing inner pleat openings, if any, by connecting inner edge of sintered metal fiber fleece to the inner wall of said filter element.

12. Method of providing a filter element comprising the steps:
pleating a sintered metal fiber fleece;
bending said pleated sintered metal fiber fleece by bringing straight edges to each other in order to obtain pleating lines extending outwards from a central axis, providing inner pleat openings and a open core area;
closing said straight edges;
squeezing outer edge of said sintered metal fiber fleece between a upper and a lower part of the outer wall of said filter element, said upper and lower part of said outer wall being formed at one side according to the wave shape of said outer edge of said sintered metal fiber fleece;
inserting a sintered metal fiber tube, with an outer diameter which is greater or equal to the diameter of the central core area, in said open core area;
inserting one or more cylindrical or conical elements in sintered metal fiber tube, so pressing sintered metal fiber tube against inner pleat openings.

13. Method of providing a filter element comprising the steps:
pleating a sintered metal fiber fleece;
bending said pleated sintered metal fiber fleece by bringing straight edges to each other in order to obtain pleating lines extending outwards from a central axis, providing inner pleat openings and a open core area;
closing said straight edges;
squeezing outer edge of said sintered metal fiber fleece between a upper and a lower part of the outer wall of said filter element, said upper and lower part of said outer wall being formed at one side according to the wave shape of said outer edge of said sintered metal fiber fleece;
inserting a sintered metal fiber tube, with an outer diameter minimally equal to the diameter of the central core area, in said open core area;
inserting two slightly conical parts in the sintered metal fiber tube with smallest diameter side of said conical part pointing inwards said sintered metal fiber tube; said conical part having a smallest diameter slightly smaller than the inner diameter of said sintered metal fiber tube, a largest diameter slightly larger than said sintered metal fiber tube and a height equal to half of the length of the sintered metal fiber tube;
connecting said smallest side of said conical pats to each other by welding at middle of said sintered metal fiber tube.

14. A method to provide a filter element as in claim 10 or 13, comprising an additional step of closely fitting a second external wall round said outer wall.
